(19) United States
(12) Patent Application Publication
(10) Pub. No.: US 2008/0273352 A1
(43) Pub. Date: Nov. 6, 2008

(54) Surface Light Source Device and Liquid Crystal Display Device Using the Same

(75) Inventors: Yoshihiro Ueno, Kyoto (JP); Koichi Takemura, Kyoto (JP); Isao Makuta, Kyoto (JP); Masayuki Shinohara, Kyoto (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/792,640

(22) PCT Filed: Oct. 28, 2005
(86) PCT No.: PCT/JP2005/019892

§ 371 Date: Mar. 4, 2008

(30) Foreign Application Priority Data
Dec. 8, 2004 (JP) 2004-355785

(51) Int. Cl. F21V 8/00

(52) U.S. Cl. 362/620

(57) ABSTRACT

A protecting sheet 112 having a transparent rubber-like resin 113 formed on a transparent board 114 is interposed between a light emitting plane 123 of a light guiding plate 111 and a surface, at which prisms 116 are formed, of a prism sheet 115 in such a manner that the transparent rubber-like resin 113 is brought into contact with vertexes of the prisms 116. The transparent rubber-like resin 113 holds the prism sheet without any deformation without any application of external force, thus preventing any occurrence of an optical close contact between the prism sheet 115 and the protecting sheet 112. In contrast, the transparent rubber-like resin 113 is deformed with the application of the external force, thus preventing any breakage of the prism 116.

### TECHNICAL FIELD

The invention relates to a surface light source device and a liquid crystal display device using the same. More particularly, the invention relates to a surface light source device capable of preventing a prism sheet from being broken due to external force, wherein a light utilizing efficiency can be enhanced by the use of the prism sheet.

### BACKGROUND ART

In one example of surface light source devices, a light beam emitted from a light emitting plane of a light guiding plate is deflected in a direction perpendicular to the light emitting plane by the use of a prism sheet, thereby enhancing a light utilizing efficiency, as disclosed in Japanese Patent Application Laid-open No. 2003-215584 (Patent Literature 1).

FIG. 19 is a cross-sectional view showing a structure of a liquid crystal display device 401 in the prior art (as disclosed in, for example, Patent Literature 1). The liquid crystal display device 401 includes a liquid crystal panel 402, a light guiding plate 403, a light emitter 404, and a prism sheet 405. The light guiding plate 403 is molded with a transparent resin having a high index of refraction such as a polycarbonate resin or a methacrylic resin. At a reverse of the light guiding plate 403 are recessed diffusion patterns 406 formed into a pyramid when the light guiding plate 403 is molded. The light emitter 404 includes one or more light emitting diodes (abbreviated as “LEDs”) mounted on a circuit board, not shown, and faces a light incident plane 410 at the side surface of the light guiding plate 403. The prism sheet 405 includes a plurality of transparent prisms 408, each having an acute vertex (having a vertex angle of about 50°), formed at either surface of a transparent plastic sheet 407. Moreover, the prism sheet 405 is held on a light emitting plane 409 of the light guiding plate 403. In this manner, the light guiding plate 403 is brought into contact with the vertex of the prism 408 all the time. The liquid crystal panel 402 faces the prism sheet 405 at a surface opposite to a surface facing the light guiding plate 403. The liquid crystal panel 402 is held by a holder, although not shown, thereby defining a clearance between the liquid crystal panel 402 and the prism sheet 405, so as to prevent any contact with the prism sheet 405.

In this way, a light beam p is emitted from the light emitting plane 409 of the light guiding plate 403 in a direction substantially parallel to the light emitting plane 409, and then, is incident into the prism 408 formed at the prism sheet 405 through the air in the liquid crystal display device 401, as shown in FIG. 20A. The light beam p incident into the prism 408 is diffracted and reflected on the prism 408, and then, is deflected in a direction perpendicular to the light emitting plane 409, to be emitted in the direction perpendicular to a surface opposite to a surface, at which the prism 408 of the prism sheet 405 is formed.

However, if external force is exerted on the liquid crystal display device 401, the prism 408 is pressed against the light guiding plate 403, and therefore, the entire prism 408 or a part of the vertex of the prism 408 may be accidentally crushed. In such a case, the direction of the light beam p to be diffracted and reflected is changed at the crushed portion, and therefore, the light beam p incident into the crushed portion of the prism 408 cannot be emitted in the direction perpendicular to the light emitting plane 409, to be lost, as shown in FIG. 20B. As a consequence, there may arise problems of a decrease in frontal luminance, degradation of luminance uniformity or bad outward appearance due to a lost light beam on a screen in the liquid crystal display device 401. Such an external force may be exerted due to various causes: for example, the reverse of the light guiding plate 403 is accidentally pressed during assemblage or inspection, or the liquid crystal display device 401 hits on a corner of an inspecting tool, or the like.

FIG. 21 is a graph illustrating orientation characteristics of the light beam emitted through the prism sheet 405 (based on calculation results), wherein a horizontal axis represents a light emitting angle θ of the light beam to be emitted from the prism sheet 405 (the direction perpendicular to the prism sheet 405 is regarded as 0°) while a vertical axis expresses a relative luminance of the light beam to be emitted at each of the light emitting angles θ. Moreover, FIG. 21 illustrates the comparison between orientation characteristics when a prism sheet 405 including the prism 408 having a vertex angle of 50° is used and orientation characteristics when a prism sheet 405 including the prism 408 having a vertex angle of 60° is used. As is clear from FIG. 21, in comparison with the luminances (i.e., the frontal luminances) at an angle of 0° of the prism sheet 405, the prism sheet 405 including the prism 408 having a vertex angle of 60° is decreased in luminance less by about 20% than the prism sheet 405 including the prism 408 having a vertex angle of 50°. As a result, the vertex angle of the prism 408 should be desirably reduced in order to increase the frontal luminance in the liquid crystal display device 401. However, the reduction of the vertex angle of the prism 408 is liable to raise a problem of an easy crush in contact of the prism 408 with the light guiding plate 403.

As means for solving the above-described problems, Japanese Patent Application Laid-open No. Hei 11-305011 (Patent Literature 2) discloses that abrasion resistance of a prism sheet is enhanced by forming a vertex of a prism into an arc having a radius of curvature of 10 μm to 25 μm. With this solving means, the vertex of the prism is hardly crushed, but the increased radius of curvature of the vertex, as described above, degrades optical characteristics of the prism sheet, thereby reducing a light beam to be emitted in a direction perpendicular to the prism sheet, so as to markedly decrease a frontal luminance in a liquid crystal display device.

Otherwise, Japanese Patent Application Laid-open No. 2001-343507 (Patent Literature 3) discloses a radius of curvature of a vertex of 5 μm or less in order to suppress a decrease in frontal luminance to the minimum. However, since the vertex of the prism becomes sharp by reducing the radius of curvature of the vertex, as described above, an effect of prevention of a crush of the prism is almost diminished. In particular, an effect is seldom produced in the case of a prism sheet having a small angle of a vertex of a prism. In view of this, such a shape of the prism merely devised as described above is not enough to prevent any crush of the prism while suppressing the decrease in frontal luminance.

Alternatively, Japanese Patent Application Laid-open No. 2002-231030 (Patent Literature 4) as other measures discloses a method for protecting a prism by the use of a shock absorbent. In this method, a fluid made of a gelled or liquefied translucent material is enclosed between a cover board for covering a prism forming surface of a light guiding plate having the prism formed thereon and the prism forming surface of the light guiding plate, and thus, the fluid is used as a shock absorbent. With this method, the prism forming surface of the light guiding plate and the fluid are brought into close contact with each other not via any air layer, and therefore, since a difference in refractive index therebetween is small, a light beam cannot be sufficiently deflected by the prism, thereby decreasing the frontal luminance with a leakage of the light beam. In addition, it is very difficult to uniformly fill and seal the fluid without any mixture of foreign matters such as bubbles with the fluid, thereby raising a problem of an increase in fabrication cost.

In the meantime, the prism sheet disclosed in Japanese Patent Application Laid-open No. 2003-215584 (Patent Literature 1) may be made of a soft elastic resin. With such a prism sheet, even if the prism collides with the light guiding plate, the vertex of the prism can be prevented from being broken, and further, the prism is restored to its original shape when the prism is separated from the light guiding plate. However, the prism sheet cannot achieve excellent transferability, unlike an ultraviolet curable resin in the prior art, and further, the radius of curvature of the vertex of the prism becomes increased in molding, thereby decreasing the frontal luminance in the liquid crystal display device.

[Patent Literature 1] Japanese Patent Application Laid-open No. 2003-215584

[Patent Literature 2] Japanese Patent Application Laid-open No. 1999-305011

[Patent Literature 3] Japanese Patent Application Laid-open No. 2001-343507

[Patent Literature 4] Japanese Patent Application Laid-open No. 2002-231030

### DISCLOSURE OF THE INVENTION

### Problems to be Solved by the Invention

The invention has been accomplished to solve the above-described problems experienced by the prior art. Therefore, an object of the invention is to provide a surface light source device, in which a vertex of a prism can be prevented from being broken by external force without decreasing a frontal luminance, and further, outward appearance cannot be degraded due to an optical close contact.

### Means for Solving the Problems

A surface light source device according to the invention including: a light source; a light guiding plate having uneven patterns formed for deflecting a light beam guided inward from the light source toward a light emitting plane, so as to emit the light beam from the light emitting plane in a direction substantially parallel to the light emitting plane; and a prism sheet having a plurality of prisms formed for deflecting the light beam emitted from the light emitting plane in a direction substantially perpendicular to the light emitting plane, the prisms being arranged in such a manner as to be oriented toward the light guiding plate; comprises: a transparent protecting sheet having a predetermined elasticity at the surface thereof, the surface having the predetermined elasticity facing the prisms.

In the surface light source device according to the invention, the transparent protecting sheet having the predetermined elasticity at the surface thereof is interposed between the light guiding plate and the prism sheet, so that the prism can be prevented from being broken due to the contact of the prism sheet with the light guiding plate without decreasing the frontal luminance of the surface light source device.

In an aspect of the surface light source device according to the invention, the protecting sheet includes one or a plurality of transparent rubber-like resins, each having a predetermined elasticity, formed on a transparent board.

In the aspect according to the invention, the transparent rubber-like resin is not directly on the light emitting plane of the light guiding plate or the prism forming surface of the prism sheet, but is independently formed as the protecting sheet, thus facilitating the fabrication of the protecting sheet having uniform optical characteristics. Moreover, it is possible to achieve easy handling by forming the transparent rubber-like resin on the transparent board.

In another aspect of the surface light source device according to the invention, the surface of the protecting sheet has the predetermined elasticity such that the surface is deformed only when external force is exerted on the prism sheet. In the aspect according to the invention, since the surface of the protecting sheet is not deformed in a normal state in which no external force is exerted on the prism sheet, no material for the surface of the protecting sheet is filled between the prisms formed at the prism sheet, thereby preventing any occurrence of the optical close contact, so as not to degrade the outward appearance. In contrast, if the external force is exerted on the prism sheet, the external force can be dispersed by deforming the surface of the protecting sheet, thus preventing any breakage of the prism sheet. Furthermore, when the external force is eliminated from the state in which the external force is exerted on the prism sheet, the prism sheet is restored to the state before the exertion of the external force, thereby preventing any occurrence of the optical close contact also in this case.

In a further aspect of the surface light source device according to the invention, the surface of the protecting sheet is brought into contact with a vertex of the prism, and further, has the elasticity enough to support the prism without deforming the surface. In the aspect according to the invention, the surface light source device can be reduced in thickness.

In a still further aspect of the surface light source device according to the invention, fine beads are dispersed in the protecting sheet.

In the aspect according to the invention, since the fine beads are dispersed in the protecting sheet, the prism sheet can be protected from the external force, and further, the protecting sheet can function as a diffusing plate for diffusing and transmitting an incident light beam, thus making it unnecessary to independently dispose any diffusing plate.

A liquid crystal display device according to the invention comprises: the surface light source device according to the invention; and a liquid crystal display panel. Thus, an image display screen can be free from a breakage such as a dent even if the external force is exerted on the liquid crystal display device without increasing the thickness of the liquid crystal display device.

Incidentally, the above-described constituent elements according to the invention may be arbitrarily combined with each other as possible.

### BRIEF DESCRIPTION OF THE DRAWINGS

FIG. 1 is a cross-sectional view schematically showing a liquid crystal display device in a first preferred embodiment according to the invention.

FIG. 2A is a view schematically showing the liquid crystal display device in the first preferred embodiment according to the invention when no external force is exerted.

FIG. 2B is a view schematically showing the liquid crystal display device in the first preferred embodiment according to the invention when external force is exerted.

FIG. 3 is a diagram illustrating an optical close contact pattern which occurs at the time of an optical close contact of a protecting sheet.

FIG. 4 is a table illustrating an example of characteristics of the protecting sheet satisfying a load resistance and its constituent members.

FIG. 5 is a view showing a behavior of a light beam in a state in which a prism is embedded in the protecting sheet.

FIG. 6 is a view explanatory of a universal hardness measuring method.

FIG. 7 is a graph illustrating an elastic restoration power.

FIG. 8 is a graph illustrating a universal hardness and the elastic restoration power of evaluated protecting sheets.

FIG. 9 is a view explanatory of a method for evaluating the load resistance of the protecting sheet.

FIG. 10 is a table illustrating measurement results of the load resistance of the protecting sheet.

FIG. 11 is a side view showing a protecting sheet in a second preferred embodiment according to the invention.

FIG. 12 is a side view showing a protecting sheet in a third preferred embodiment according to the invention.

FIG. 13 is a cross-sectional view schematically showing a liquid crystal display device in a fourth preferred embodiment according to the invention.

FIG. 14 is a cross-sectional view schematically showing a liquid crystal display device in a fifth preferred embodiment according to the invention.

FIG. 15 is a view schematically explanatory of the function of a projecting pattern in the fifth preferred embodiment.

FIG. 16 is a cross-sectional view schematically showing a liquid crystal display device in a sixth preferred embodiment according to the invention.

FIG. 17 is a cross-sectional view schematically showing a liquid crystal display device in a modification of the sixth preferred embodiment.

FIG. 18 is a cross-sectional view schematically showing a liquid crystal display device in another modification of the sixth preferred embodiment.

FIG. 19 is a cross-sectional view showing a configuration of a liquid crystal display device in the prior art.

FIG. 20A is a view showing a behavior of a light beam in a normal state in a prism sheet in the liquid crystal display device in the prior art.

FIG. 20B is a view showing a behavior of a light beam in a state in which the prism sheet is broken, in the prism sheet in the liquid crystal display device in the prior art.

FIG. 21 is a graph illustrating variations in frontal luminance in a surface light source device according to an angle of a prism vertex of a prism sheet.

### EXPLANATION OF REFERENCE NUMERALS

101 liquid crystal display device
102 surface light source device
111 light guiding plate
112, 211, 214 protecting sheet
113 transparent rubber-like resin
114 transparent board
115 prism sheet
117 liquid crystal panel
118 holder
119 reflecting plate
122 light source
123 light emitting plane
124 light diffusion pattern
125 light incident plane
130 measurement table
131 glass plate
132 Vickers penetrator
133 pressing surface
212 first transparent rubber-like resin
213 second transparent rubber-like resin
216 bead

### BEST MODES FOR CARRYING OUT THE INVENTION

Preferred embodiments according to the invention will be described below in reference to the attached drawings. Here, it is to be understood that the invention should not be restricted to the preferred embodiments, described below.

### First Preferred Embodiment

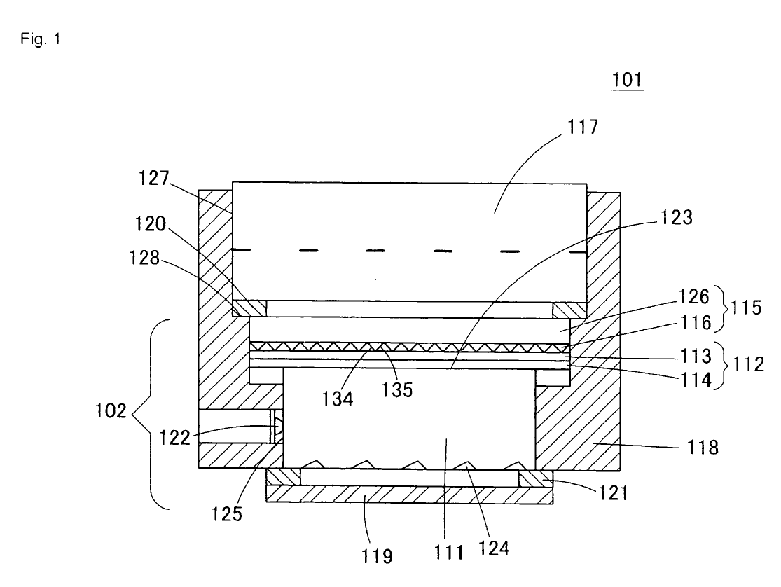

FIG. 1 is a cross-sectional view schematically showing a liquid crystal display device 101 in a first preferred embodiment according to the invention. Here, FIG. 1 schematically shows the liquid crystal display device 101, which is actually formed into a plane with thinness in a thickness direction. The liquid crystal display device 101 includes a liquid crystal panel 117, a surface light source device 102, and a holder 118 for securely holding the liquid crystal panel 117 and the surface light source device 102.

The liquid crystal panel 117 and the surface light source device 102 are arranged in such a manner that the liquid crystal panel 117 faces the light emission side of the surface light source device 102, and further, are housed inside a through hole 127 formed at the center of the holder 118. The liquid crystal panel 117 is slightly greater than the surface light source device 102. The liquid crystal panel 117 is held at a stepped surface 128 formed inside of the through hole 127 of the holder 118 by winding the periphery with a first double-sided tape 120, thereby defining a clearance between the surface light source device 102 and the liquid crystal panel 117. As a consequence, if no external force is exerted, the liquid crystal panel 117 cannot be brought into contact with the surface light source device 102.

The surface light source device 102 includes a light guiding plate 111, a prism sheet 115, a protecting sheet 112, a light source 122 and a reflecting plate 119. The light guiding plate 111 is molded with a transparent resin having a high index of refraction such a polycarbonate resin or a methacrylic resin. Moreover, diffusion patterns 124 formed into a triangular pyramid are recessed at the reverse of the light guiding plate 111 in molding the light guiding plate 111.

The light source 122 is constituted by sealing one or several LEDs in a transparent mold resin, and then, covering a surface other than a front surface of the mold resin with a white resin, although not particularly shown. A light beam emitted from the LED is reflected directly or on an interface between the mold resin and the white resin, to be then emitted from the front surface of the light source 122. The light source 122 faces, at the front surface thereof, a light incident plane 125 formed at a side surface of the light guiding plate 111.

The reflecting plate 119 is subjected to mirror-finishing by plating its surface with Ag, and it is disposed in such a manner as to face the entire reverse of the light guiding plate 111. Moreover, the reflecting plate 119 is adhesively secured at the periphery thereof to the holder 118 via a second double-sided tape 121.

The prism sheet 115 includes a prism 116 having an incident plane 134 and a reflecting plane 135 at a surface facing the light guiding plate 111. The prism 116 is molded by dropping an ultraviolet ray curable resin at an upper surface of a plastic sheet 126, pressing the ultraviolet ray curable resin by a stamper, spreading the ultraviolet ray curable resin between the stamper and the plastic sheet 126, and then, curing the ultraviolet ray curable resin with the irradiation of ultraviolet rays (i.e., photo polymerization). A surface opposite to the surface, at which the prism 116 is formed, faces the liquid crystal panel 117. The prism 116 has a uniformly cross-sectional shape in the preferred embodiment, as shown, and is formed in the entire width of the plastic sheet 126 along a direction parallel to the light incident plane 125.

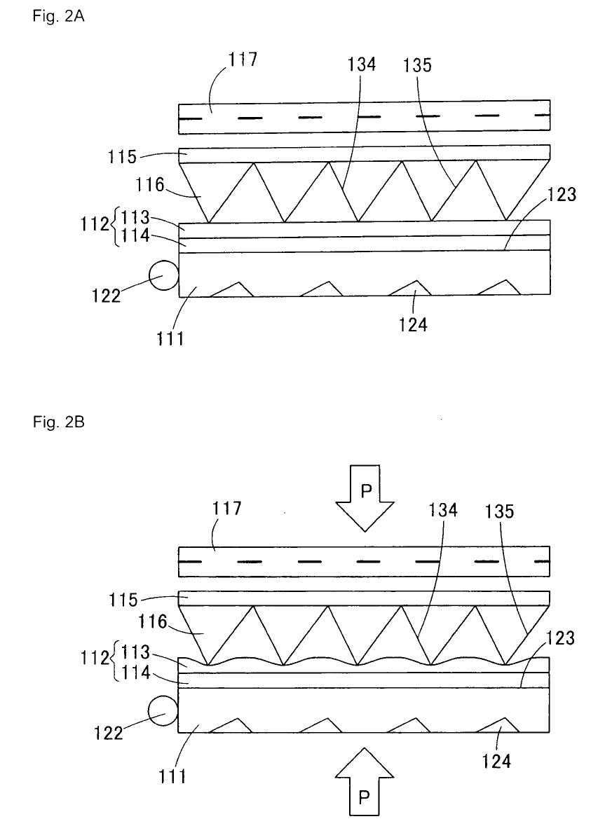

The protecting sheet 112 is interposed between the light guiding plate 111 and the prism sheet 115, and is formed by laminating a transparent rubber-like resin 113 on a transparent board 114. The transparent board 114 faces a light emitting plane 123 of the light guiding plate 111: in contrast, the transparent rubber-like resin 113 faces the prism sheet 115 at the surface, at which the prism 116 is formed. As shown in FIG. 2A, the transparent rubber-like resin 113 is disposed in such a manner as to be brought into contact with the vertex of the prism 116, and therefore, holds the prism sheet 115 without any deformation. Furthermore, the prism 116 is protectively embedded in the transparent rubber-like resin 113 in a state in which external force P is exerted on the surface light source device 102, as shown in FIG. 2B, thereby preventing any breakage of the prism 116. In contrast, the prism 116 is not embedded in the transparent rubber-like resin 113 in a state in which no external force P is exerted, as shown in FIG. 2A, thereby holding the prism sheet 115, and further, preventing any optical close contact between the transparent board 114 and the light emitting plane 123 of the light guiding plate 111. In addition, when the external force P is eliminated in the state in which the external force P is exerted, the state is restored to the original state before the external force P is exerted.

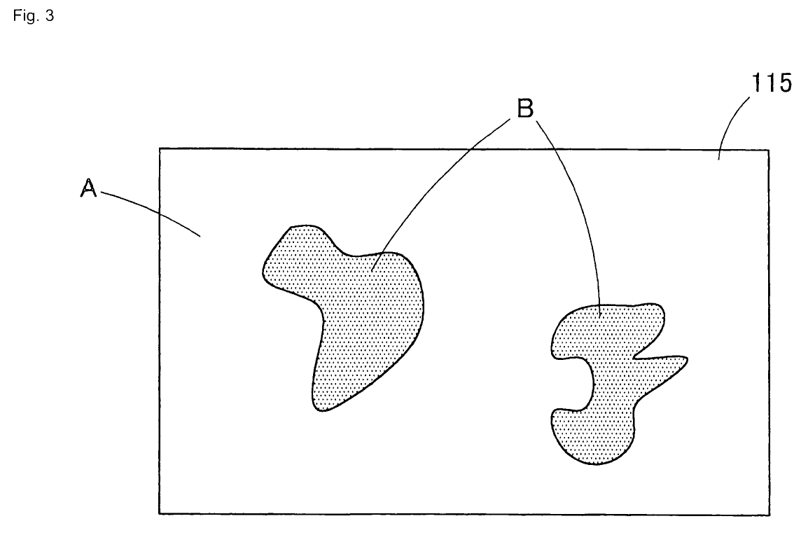

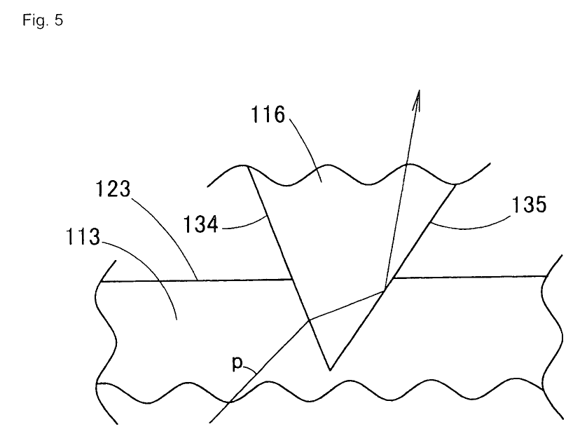

The optical close contact herein signifies a status which induces a phenomenon in which patterns different in luminance (i.e., optical close contact patterns) such as a region A and a region B (i.e., a region having a satin pattern) accidentally occur when a light beam transmitting the prism sheet 115 is observed, as shown in FIG. 3, caused by the embedding of the prism 116 in the transparent rubber-like resin 113. The optical close contact pattern occurs at a portion at which the prism 116 is embedded in the transparent rubber-like resin 113 due to the deformation of the transparent rubber-like resin 113, as shown in FIG. 5, since a light beam p emitted from the transparent rubber-like resin 113 is incident directly into the prism 116 not through an air layer in a diffraction direction different from the case where the light beam transmits through the air layer. Otherwise, another optical close contact may occur as a multi-color pattern consisting of various colors when an interval of the air layer between the light emitting plane 123 of the light guiding plate 111 and the transparent board 114 of the protecting sheet 112 satisfies a condition of formation of an interference pattern if the protecting sheet 112 is locally waved or warped when the external force P is exerted on the protecting sheet 112. This is a phenomenon in which a group of colored patterns (or a light and dark pattern with a monochromatic light beam) occurs around a point at which two incompletely parallel glass plates are in closest contact with each other with either a reflected light beam or a transmitting light beam when the glass plates are brought into contact with each other. This optical close contact occurs as a result of an optical interference caused by the air layer between the glass plates. The occurrence of the optical close contact mars the outward appearance of the surface light source device 102.

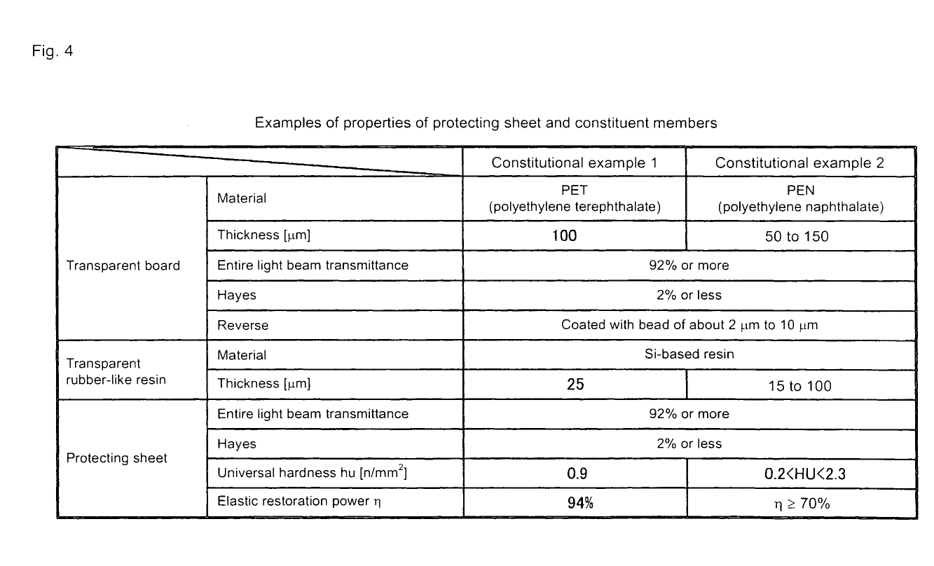

FIG. 4 shows constitutional examples of the protecting sheet 112 which satisfies conditions of a resistance of the prism ten times that in the prior art, no optical close contact, and a frontal luminance decrease ratio of 10% or less than that in the prior art. Incidentally, Constitutional Example 1 in FIG. 4 describes properties which seem to be more optimum within the properties of the protecting sheet 112 described in Constitutional Example 2 (except for a material of the transparent board).

Next, explanation will be made on each of parameters shown in FIG. 4. The transparent board 114 of the protecting sheet 112 shown in the first preferred embodiment was made of commercially available polyethylene terephthalate (PET) or polyethylene naphthalate (PEN) having a high transmittance, and further, a silicon-based rubber-like resin was used as the transparent rubber-like resin 113. The transparent board 114 and the transparent rubber-like resin 113 were selected in such a manner that the surface light source device 102 had a frontal luminance decrease ratio of 10% or less in reference to the frontal luminance of the surface light source device in the prior art. The entire light beam transmittance of the selected transparent board 114 was 92% or more in consideration of an influence of Fresnel reflection, and further, the Hayes was 2% or less (that is, the light beam was hardly diffused). Since the entire light beam transmittance and Hayes could not be measured only with the transparent rubber-like resin 113, the entire light beam transmittance and Hayes of the protecting sheet 112 were measured, resulting in 92% or more and 2% or less, respectively, in consideration of the Fresnel reflection with few influence by the transparent rubber-like resin 113. Here, the Hayes is expressed by (a diffusion transmittance/the entire light beam transmittance)×100, which designates a diffusion degree of the light beam transmitting a sample. The entire light beam transmittance and Hayes were measured in conformity with JIS-K7105.

The minimum thickness of the transparent rubber-like resin 113 need be about a half of a height of the prism 116. This is because when the prism 116 is pushed down to a half level of the transparent rubber-like resin 113, the transparent rubber-like resin 113 raised by the embedded prism 116 is relieved to the air layer between the prisms 116, and then, fills the entire air layer between the prisms 116. For example, in the case where the height of the prism 116 is 30 μm, the transparent rubber-like resin need be 15 μm in thickness to the minimum.

It is desirable from the viewpoint of thinness that the thickness of the protecting sheet 112 should be set to about 65 μm to 250 μm. If the protecting sheet 112 is thinner than 65 μm, the protecting sheet 112 is weak in stiffness, and therefore, the protecting sheet 112 is bent by its own weight in assembling, thereby deteriorating handling performance, or the protecting sheet 112 is warped due to a difference in coefficient of thermal expansion between the transparent rubber-like resin 113 and the transparent board 114 in the case where the device is left at high temperature for a long period of time inside of an automobile in summer or the like, whereby the optical close contact is liable to occur between the protecting sheet 112 and the light guiding plate 111 or between the protecting sheet 112 and the prism sheet 115. With a thickness to some extent, the external force P acts, so that the protecting sheet 112 can be restored even when the protecting sheet 112 is locally warped. However, if the protecting sheet 112 is thinner than 65 μm, there may possibly occur the optical close contact between the protecting sheet 112 and the light guiding plate 111 or between the protecting sheet 112 and the prism sheet 115.

Alternatively, formation of finely projecting patterns at the reverse of the transparent board 114 or the light emitting plane 123 of the light guiding plate 111 can prevent any optical close contact from occurring as a result of the optical interference caused by the air layer between the light emitting plane 123 of the light guiding plate 111 and the protecting sheet 112. When the projecting patterns are formed at the light guiding plate 111, recessed patterns are formed at a die by subjecting the die on a side of the light emitting plane 123 of the light guiding plate 111 to blasting, so that the projecting patterns are formed on the light emitting plane 123 by inversing the recessed patterns formed on the die when the light guiding plate 111 is formed. Otherwise, the projecting patterns can be formed on the transparent board 114 by coating a side of the transparent board 114 facing the light emitting plane 123 of the light guiding plate 111 with a transparent resin including fine powder (i.e., beads) in mixture (i.e., bead coating). In this case, it was confirmed that no optical close contact occurred if the size of a bead was greater than 2 μm. Moreover, the finely projecting patterns are formed at the reverse of the transparent board 114 or the light emitting plane 123 of the light guiding plate 111, or the reverse of the transparent board 114 or the light emitting plane 123 of the light guiding plate 111 is subjected to the bead coating, thereby equipping the prism sheet 115 or the light guiding plate 111 with a light diffusing effect, so as to reduce variations in luminance.

As shown in FIG. 2A, the transparent rubber-like resin 113 cannot be deformed to hold the prism sheet 115, and further, no optical close contact occurs between the transparent board 114 and the light guiding plate 111 in the state in which no external force P is exerted on the surface light source device 102. In contrast, when the external force P within an imaginary range is exerted, the deformation of the transparent rubber-like resin 113 of the protecting sheet 112 can prevent any breakage of the prism 116, as shown in FIG. 2B. Furthermore, when the external force P is eliminated after the external force P is exerted, the protecting sheet 112 need be restored to the original state before the external force P is exerted, as shown in FIG. 2A.

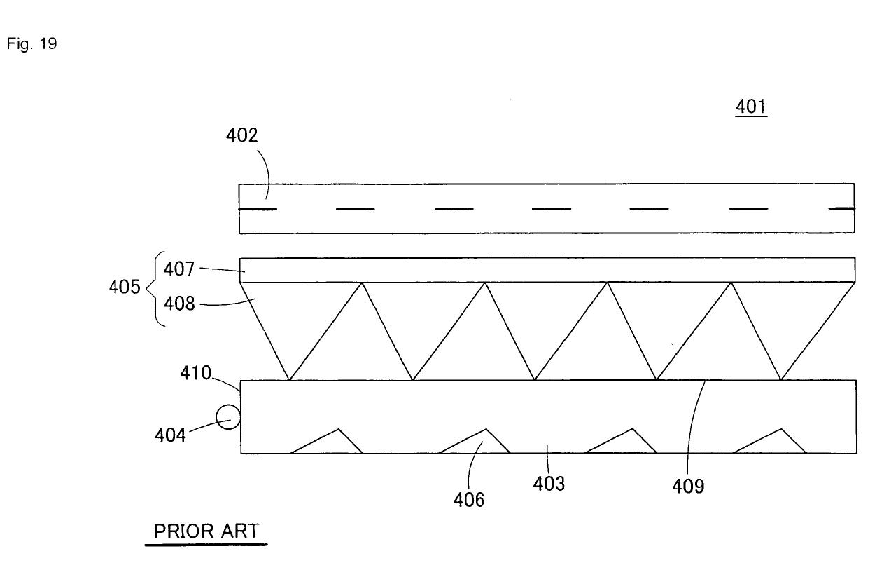

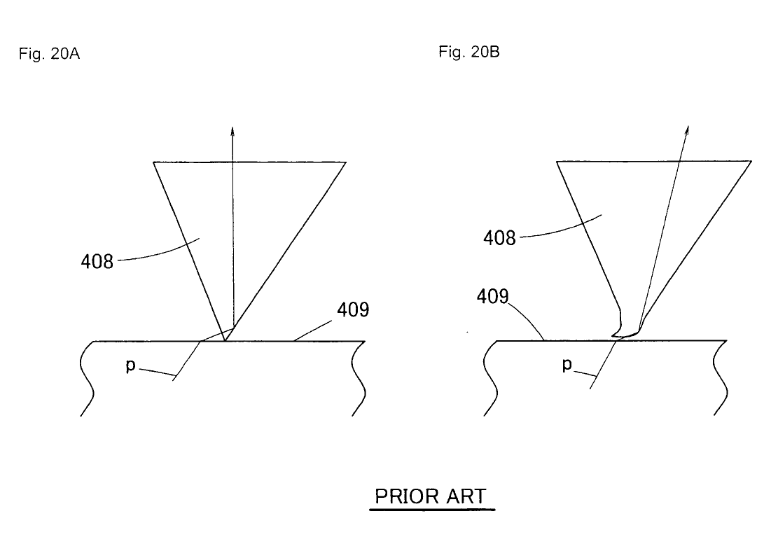

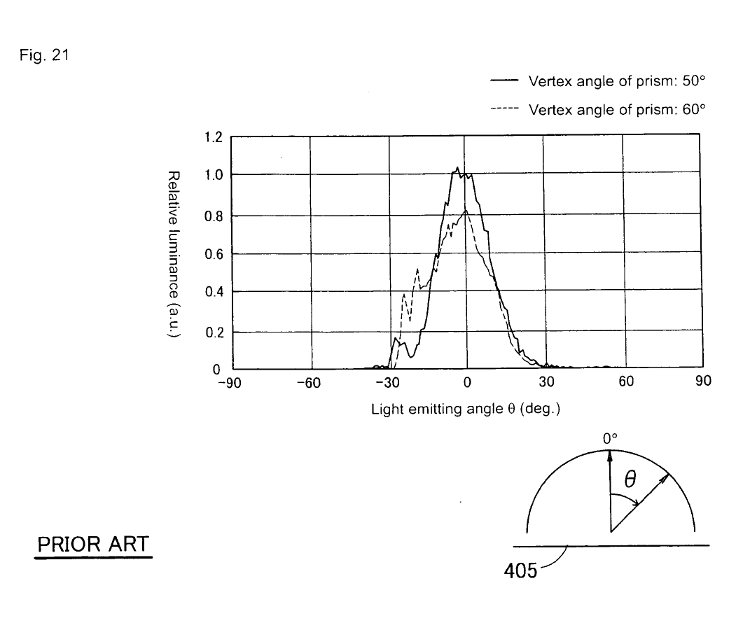

That is to say, if the prism 116 is broken by the external force P, the broken portion of the prism 116 is changed in orientation in the same manner as in the prior art shown in FIG. 19B, and therefore, the light beam incident into the broken portion of the prism 116 cannot be emitted in a vertical direction but is lost, thereby decreasing the frontal luminance, degrading luminance uniformity and marring the outward appearance due to the lost light beam. When the deformation of the transparent rubber-like resin 113 forces the prism 116 to be embedded into the transparent rubber-like resin 113 in the state in which no external force P is exerted, the optical close contact pattern is formed, as shown in FIG. 3, thereby marring the outward appearance.

In the liquid crystal display device 101 in the first preferred embodiment, requirements capable of satisfying the above-described load resistance characteristics were found, through an experiment, to be such that the universal hardness was greater than 0.2 N/mm² and smaller than 2.3 N/mm² and the elastic restoration power was 70% or more.

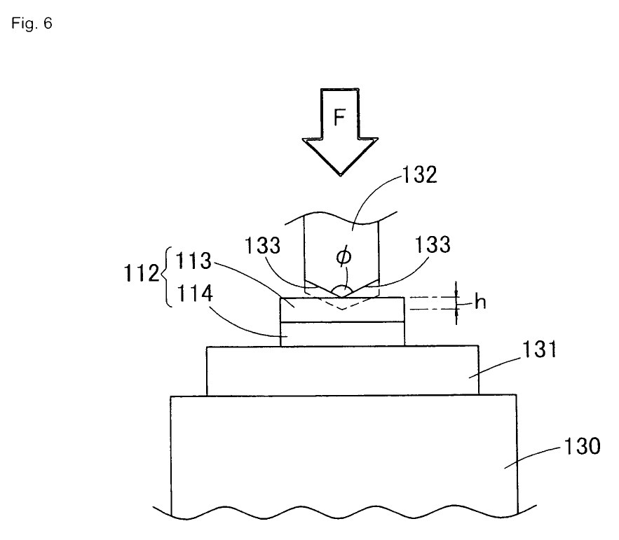

Prior to explaining an experiment for determining the ranges of the universal hardness (HU) and elastic restoration power, simple explanation will be made on the universal hardness and the elastic restoration power. First of all, the universal hardness is obtained by a test with a configuration shown in FIG. 6 (ISO 14577-1 standard). In this test, a flat glass plate 131 and a sample to be measured (i.e., the protecting sheet 112 according to the invention) are laminated in sequence on a measurement table 130, and then, a Vickers penetrator 132 having a pyramidal tip is depressed in the sample to be measured with the application of a load F. A broken line in FIG. 6 indicates the Vickers penetrator 132 depressed in the sample (i.e., the protecting sheet 112) with the application of the load. The universal hardness is measured with the application of the load. Assume that reference character As designates an area of a portion of a pressing surface 133 of the Vickers penetrator 132 in contact with the sample, the universal hardness is expressed by F/As by using the pushing load F during the test. A normal angle φ of the tip of the Vickers penetrator 132 is 136°. In this case, assume that reference character h denotes a pushing quantity during the test, the universal hardness is expressed by F/(26.43×h²).

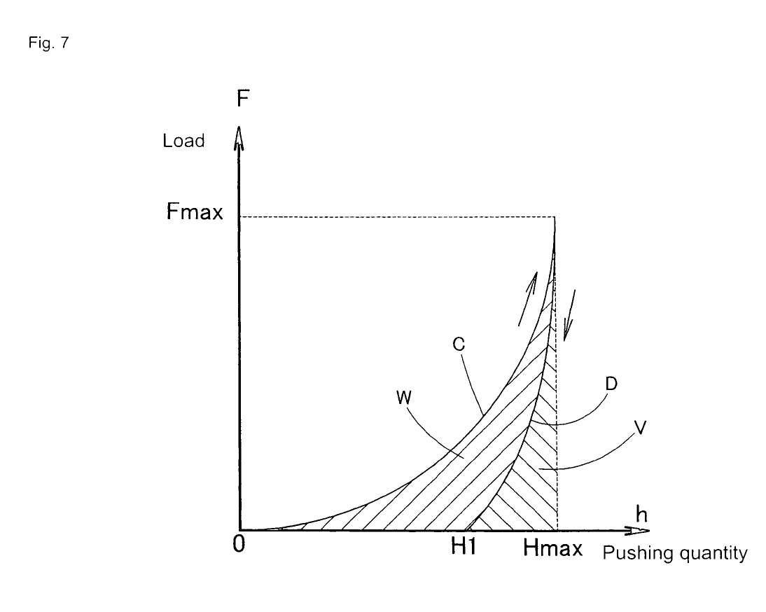

The above-described test reveals a graph illustrating the relationship between the pushing load F and the pushing quantity h in FIG. 7. FIG. 7 is a graph in which a horizontal axis represents the pushing quantity h and a vertical axis represents the pushing load F. A curve C in FIG. 7 illustrates the relationship between the pushing load F and the pushing quantity h as the pushing load F is increased. In contrast, a curve D illustrates the relationship between the pushing load F and the pushing quantity h as the pushing load F is decreased. A region V is obtained by integrating the pushing load F along the curve D by the pushing quantity h within a range from a pushing quantity H1 corresponding to a minimum load (here, zero) to a pushing quantity Hmax corresponding to a maximum load Fmax on the curve D, and it is referred to as an elastic power. In contrast, a region W is obtained by integrating a difference between the pushing load F along the curve C and the pushing load F along the curve D by the pushing quantity h within a range from the pushing quantity h of 0 to the pushing quantity Hmax corresponding to the maximum load Fmax, and it is referred to as a plastic power. In addition, the sum (i.e., the plastic power and the elastic power) of the region C and the region D is referred to as a total power. Furthermore, the elastic restoration power represents a ratio of the elastic power to the total power, and therefore, it is expressed by dividing the elastic power by the total power.

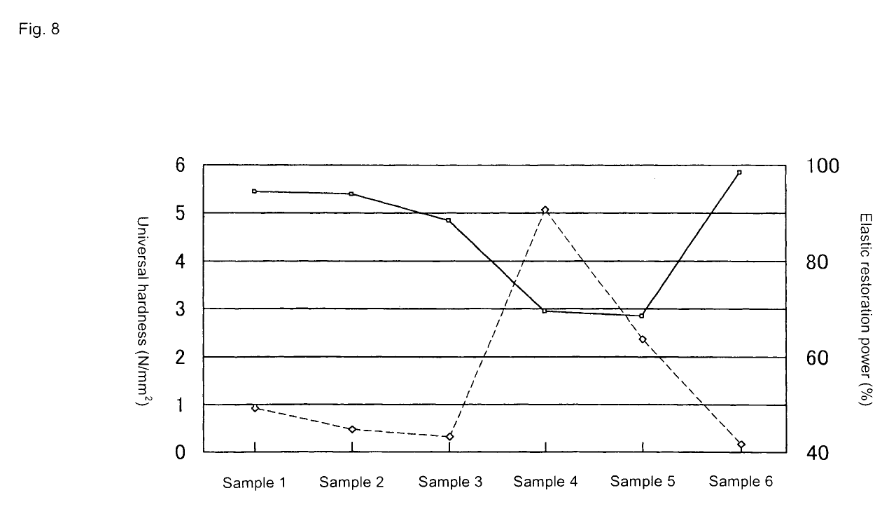

Subsequently, the universal hardness and the elastic restoration power were measured by the test explained in reference to FIG. 6, and then, six types of protecting sheets 112 (Samples 1 to 6) were evaluated. FIG. 8 is a graph illustrating the universal hardness and elastic restoration power of each of evaluated samples. Solid squares and a solid line indicate the elastic restoration power (%) of each of the samples: in contrast, solid rectangles and a broken line indicate the universal hardness (N/mm²) of each of the samples. In the first preferred embodiment, the universal hardness and the elastic restoration power were measured by using H100C manufactured by Fisher Scope Co., Ltd. Since the transparent rubber-like resin 113 had a thickness of about 25 μm, the universal hardness and the elastic restoration power were measured under the conditions that the maximum pushing quantity of the Vickers penetrator 132 was set to 2 μm, the Vickers penetrator 132 pushed for 5 seconds after the beginning of the application of the pushing load F until the pushing quantity became maximum while it took 5 seconds until the pushing load F was decreased down to zero (that is, a pushing speed was about 0.4 μm/sec.) in order to prevent measurement values from being adversely influenced. Each of the protecting sheets 112 was measured triple, and the average was regarded as a measurement value. Here, the measurement was carried out in the environment of a temperature of 23° C. and a humidity of 50%.

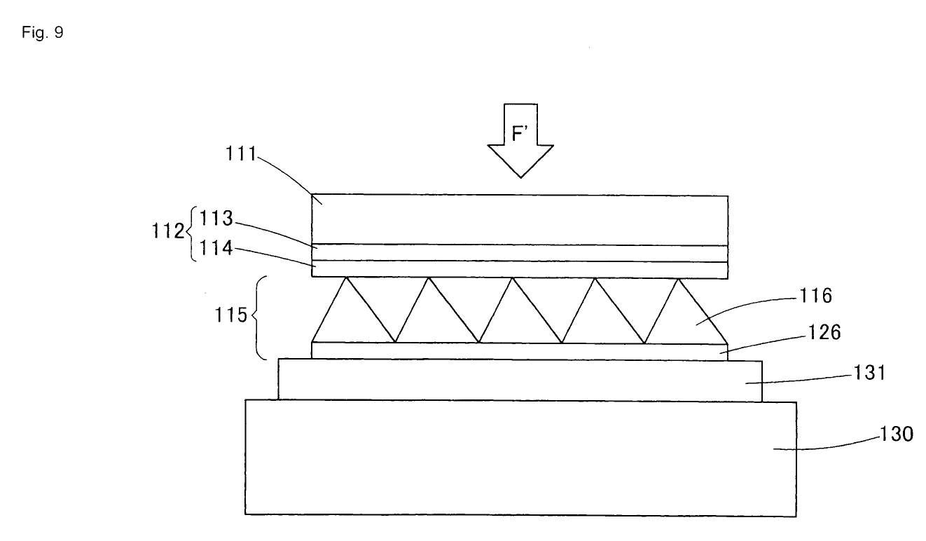

FIG. 9 is a view showing a configuration when the load resistance (i.e., resistance to breakage of the vertex of the prism and resistance to a dent remaining on the transparent rubber-like resin) of the protecting sheet 112 is evaluated. In particular, the flat glass plate 131 was mounted on the measurement table 130, and further, the surface opposite to the surface of the prism sheet 115 having the prism 116 in the surface light source device 102 incorporating therein any one of Samples 1 to 6 was placed on the flat glass plate 131. More particularly, the prism sheet 115 was mounted on the glass plate 131 in such a manner that the prism 116 was oriented upward, and further, the protecting sheet 112 was disposed opposite to the prism 116 on the side of the transparent rubber-like resin 113, and finally, the light emitting plane 123 of the light guiding plate 111 was placed on the transparent board 114.

Next, a predetermined load F′ was exerted on a plane opposite to the light emitting plane 123 of the light guiding plate 111, and then, the surface light source device 102 was lighted. As a result, it was visually determined as to whether or not the appearance was marred. In addition, it was visually confirmed as to whether or not the protecting sheet 112 (i.e., each of Samples 1 to 6) was damaged. Incidentally, the prism sheet 115 was made of a material having a density of 9.5×10⁻⁴ g/mm³ and a universal hardness of about 9.2 N/mm².

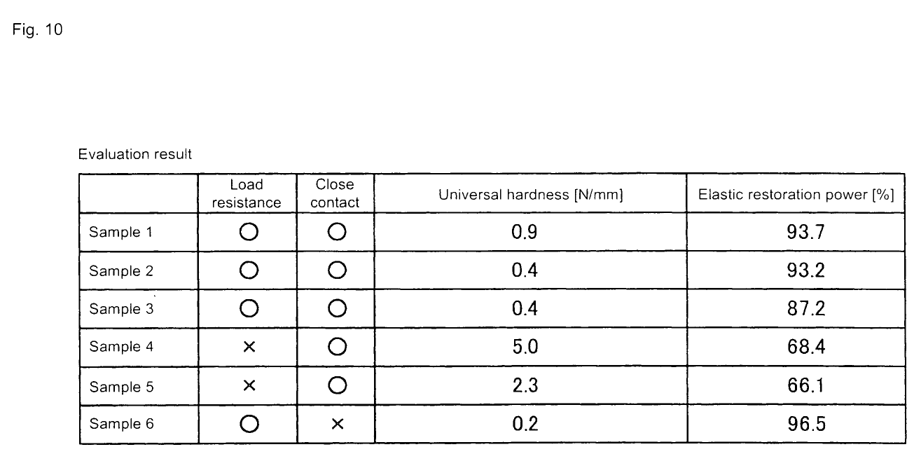

FIG. 10 shows evaluation results of Samples 1 to 6. In the evaluation shown in FIG. 10, a cross indicates the occurrence of the optical close contact in the column of “Close Contact”; and it indicates the breakage of the vertex of the prism 116 and the dent onto the transparent rubber-like resin 113 in the column of “Load Resistance”. In contrast, a circle indicates no occurrence.

With the configuration of the liquid crystal display device 101 in the first preferred embodiment, the optical close contact occurred if the universal hardness was 0.2 N/mm² or less (Sample 6); the vertex of the prism 116 was broken and the transparent rubber-like resin 113 remained dented if the universal hardness was 2.3 N/mm² or more (Samples 4 and 5). In addition, the vertex of the prism 116 was broken and the transparent rubber-like resin 113 remained dented if the elastic restoration power was 70% or less (Samples 4 and 5).

It is found from the above description that the universal hardness need be more than 0.2 N/mm² and less than 2.3 N/mm² and the elastic restoration power need be 70% or more in order to secure the load resistance in the configuration of the liquid crystal display device 101 in the first preferred embodiment.

As a consequence, the protecting sheet 112 including the transparent rubber-like resin 113 formed on the transparent board 114 is interposed between the light guiding plate 111 and the prism sheet 115 in such a manner that the transparent rubber-like resin 113 is disposed on the side of the prism sheet 115, and further, the transparent rubber-like resin 113 is featured in that the transparent rubber-like resin 113 cannot be deformed only by the self weight of the prism sheet 115, that is, the transparent rubber-like resin 113 is deformed only with the application of the external force stronger than usual, thus preventing any occurrence of the optical close contact in the normal state, and preventing any breakage of the prism sheet 115 or any damage on the protecting sheet 112 even if the external force acts within the imaginary range while suppressing the decrease in frontal luminance to the minimum. In other words, the protecting sheet 112 including the transparent rubber-like resin 113 having the proper universal hardness and elastic restoration power, which were measured by the method explained in reference to FIGS. 6 and 7, is interposed between the light guiding plate 111 and the prism sheet 115, thus enhancing the load resistance of the liquid crystal display device 101 and the surface light source device 102.

Furthermore, the protecting sheet 112 is not formed directly on the light guiding plate 111 but formed as an independent sheet, thus facilitating the fabrication of the protecting sheet 112 having the uniform optical characteristics. Moreover, the protecting sheet 112 is not deformed by the self weight of the prism sheet 115, thus making it unnecessary to dispose a special fixing mechanism for fixing the prism sheet 115. Additionally, the air layer can be held between the prisms 116 formed on the prism sheet 115 only by placing the prism sheet 115 on the protecting sheet 112, thus efficiently emitting the light beam in the vertical direction with the inexpensive configuration even if the surface light source device 102 is not made thicker than required.

### Second Preferred Embodiment

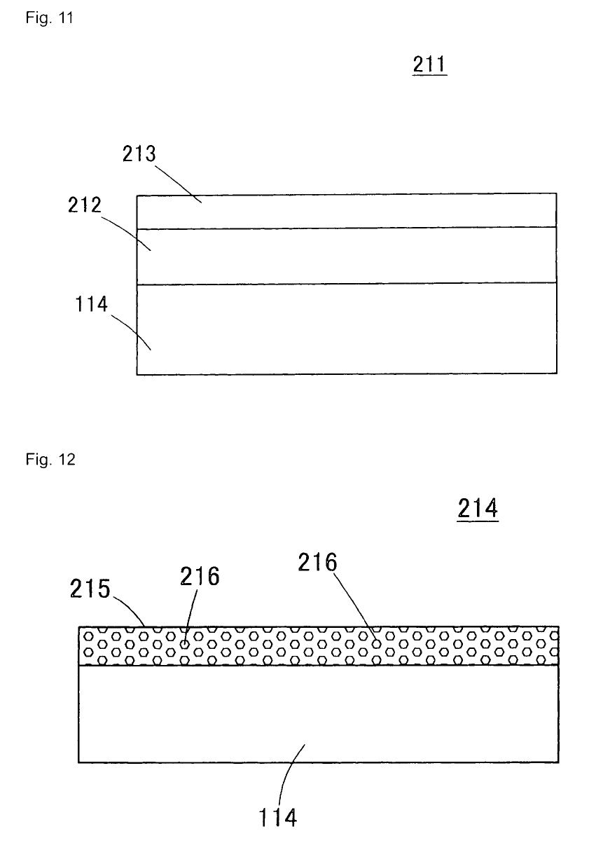

A protecting sheet in a second preferred embodiment is different in configuration from the protecting sheet 112 for use in the liquid crystal display device 101 in the first preferred embodiment. FIG. 11 is a side view showing a protecting sheet 211 in the second preferred embodiment according to the invention. The protecting sheet 211 has a double-layered structure consisting of a first transparent rubber-like resin 212 formed on a transparent board 114 and a second transparent rubber-like resin 213 formed on the first transparent rubber-like resin 212. For example, the protecting sheet 211 is configured such that the second transparent rubber-like resin 213 mainly prevents any optical close contact with a prism sheet 115, and further, that the first transparent rubber-like resin 212 mainly prevents any breakage of a prism 116 against external force. In other words, the second transparent rubber-like resin 213 is made of a slightly harder transparent rubber-like resin, and thus, has a feature of no occurrence of an optical close contact without any deformation caused by the self weight of the prism sheet 115: in contrast, the first transparent rubber-like resin 212 is made of a resin softer than the second transparent rubber-like resin 213, and therefore, it is deformed with the application of the external force, thereby preventing any breakage of the vertex of the prism 116 formed at the prism sheet 115.

Consequently, since rolls can be allotted to the first transparent rubber-like resin 212 and the second transparent rubber-like resin 213, respectively, required performance (i.e., a load resistance) can be implemented within a range wider than that of the characteristics of the protecting sheet 112 in the first preferred embodiment by effectively combining transparent rubber-like resins having different characteristics with each other. In addition, since there are more kinds of usable materials, cost reduction is achieved with a more inexpensive material or a high-value-added product can be fabricated by using a material having a new function. Incidentally, although three or more transparent rubber-like resins may be laminated, the total number of layers should be preferably smaller from the viewpoint of mass production, and therefore, two layers or so should be desirably laminated. It is to be understood that the degree of freedom of combination of resins for use in each of layers should become greater as the number of layers becomes greater.

### Third Preferred Embodiment

A protecting sheet in a third preferred embodiment is different in configuration from the protecting sheet 112 for use in the liquid crystal display device 101 in the first preferred embodiment. FIG. 12 is a side view showing a protecting sheet 214 for use in the third preferred embodiment according to the invention. The protecting sheet 214 includes a transparent rubber-like resin 215 formed on a transparent board 114, wherein beads 216 or the like are mixed in the transparent rubber-like resin 215. As a consequence, it is possible to prevent any breakage of a prism sheet 115 caused by external force, and further, to reduce variations in luminance by equipping the protecting sheet 214 with a diffusing plate.

Here, a frontal luminance becomes lower than that in the protecting sheet without any beads or the like mixed in the transparent rubber-like resin 215. Therefore, it is necessary to mix the beads 216 at a density enough to secure the required frontal luminance. Additionally, there may be provided a function of readily correcting the variations in luminance by partly varying the density of the beads 216 in the transparent rubber-like resin 215.

In the third preferred embodiment, the protecting sheet 214 may be equipped with a diffusing plate by dispersing the beads 216 in not the transparent rubber-like resin 215 but the transparent board 114, or dispersing the beads 216 in both of the transparent rubber-like resin 215 and the transparent board 114.

Although the description has been given of the liquid crystal display device of a single-sided light emitting type according to the invention, the protecting sheet may be incorporated in a liquid crystal display device of a double-sided light emitting type and a double-sided light emitter for use in such a liquid crystal display device.

### Fourth Preferred Embodiment

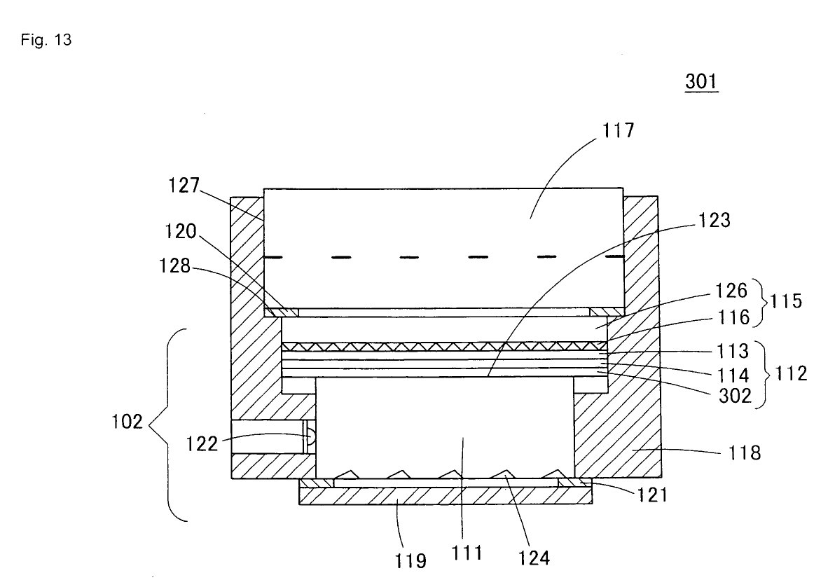

FIG. 13 is a cross-sectional view schematically showing a liquid crystal display device 301 in a fourth preferred embodiment according to the invention. The liquid crystal display device 301 in the fourth preferred embodiment is different in structure from the liquid crystal display device 101 and the protecting sheet 112 in the first preferred embodiment.

The protecting sheet 112 for use in the fourth preferred embodiment integrally includes a transparent rubber-like resin 113 laminated at an upper surface of a transparent board 114 and another transparent rubber-like resin 302 laminated also at a lower surface of the transparent board 114. Although the transparent rubber-like resin 302 laminated at the lower surface may be made of the same material as that of the transparent rubber-like resin 113 laminated at the upper surface, they may be made of different materials as long as it is a transparent rubber-like resin.

The transparent rubber-like resin 302 formed at the lower surface is air-tightly brought into close contact with a light emitting plane 123 of a light guiding plate 111. The protecting sheet 112 and the light guiding plate 111 are integrated with each other by bringing the transparent rubber-like resin 302 into close contact with the light emitting plane 123. In order to bring the transparent rubber-like resin 302 into close contact with the light emitting plane 123, the transparent rubber-like resin 302 may be brought into close contact with the light emitting plane 123 by utilizing the viscoelasticity of the transparent rubber-like resin 302, or the transparent rubber-like resin 302 may be brought into close contact with the light emitting plane 123 by the use of an adhesive agent or matching oil. Here, since a light beam transmits through the protecting sheet 112, a material of each of the layers constituting the protecting sheet 112 should preferably have little light absorption and a low light diffusion.

Although the air layer has been formed between the light emitting plane 123 and the reverse of the transparent board 114 by forming the projecting pattern on either the light emitting plane 123 or the transparent board 114 or mixing the beads in the first preferred embodiment, the light emitting plane 123 and the transparent rubber-like resin 302 are brought into close contact with each other in the fourth preferred embodiment, thereby forming no air layer between the light guiding plate 111 and the protecting sheet 112.

As a consequence, the projecting pattern or the beads, which are provided for preventing any close contact in the first preferred embodiment, become unnecessary in the liquid crystal display device 301 in the fourth preferred embodiment, thereby enhancing the frontal luminance of the liquid crystal display device 301 since the light beam emitted from the light guiding plate 111 cannot be diffused due to the projecting pattern or the beads. However, the protecting sheet 112 can be displaced in a direction of the force in parallel to the light guiding plate 111 if the force is slantwise exerted on the prism sheet 115 in the configuration of the first preferred embodiment in which the protecting sheet 112 is not brought into close contact with the light guiding plate 111, thereby producing a more excellent effect of impact absorption.

Incidentally, the lower surface of the transparent board 114 may be brought into close contact with the light emitting plane 123 with the adhesive agent or the matching oil also in the case of the use of the protecting sheet 112 including the transparent board 114 and the light emitting plane 123, like in the first preferred embodiment.

Although the transparent rubber-like resins 113 and 302 are laminated on both sides of the transparent board 114 in the fourth preferred embodiment, the protecting sheet 112 may include only the transparent rubber-like resin 113 in the case of small importance of the handling performance of the protecting sheet 112. In this case, the prism sheet 115 is protected at the upper surface of the transparent rubber-like resin 113 whose lower surface is brought into close contact with the light emitting plane 123 of the light guiding plate 111.

### Fifth Preferred Embodiment

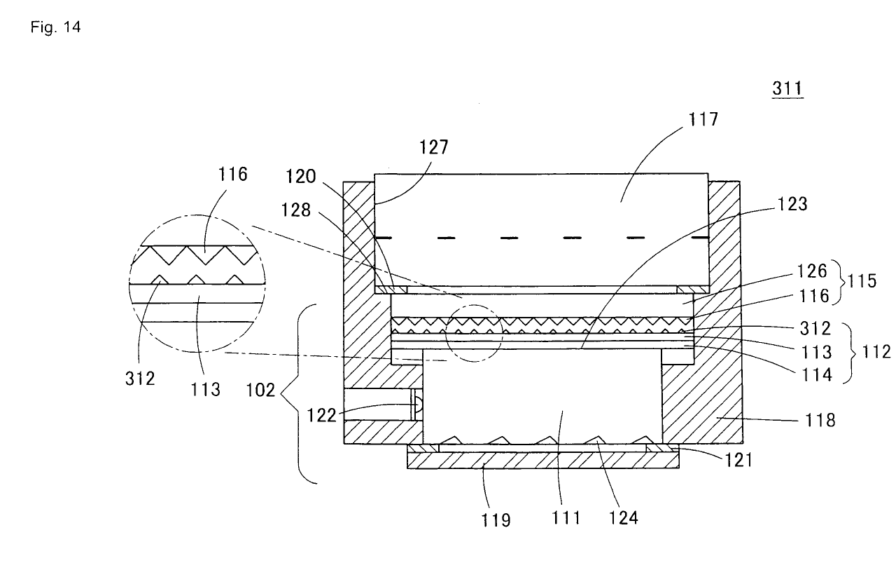

FIG. 14 is a cross-sectional view schematically showing a liquid crystal display device 311 in a fifth preferred embodiment according to the invention. A protecting sheet 112 for use in the fifth preferred embodiment includes a transparent rubber-like resin 113 laminated at an upper surface of a transparent board 114, and further, numerous fine patterns 312, which are made of the same material as that of the transparent rubber-like resin 113, are formed at an upper surface of the transparent rubber-like resin 113. The fine pattern 312 is finer than a prism 116 formed at a prism sheet 115: namely, it has a height of, for example, several microns to 10 microns.

The above-described fine patterns 312 are formed at the surface of the protecting sheet 112, so that the transparent rubber-like resin 113 is hardly brought into close contact with the vertex of the prism 116, thus more preventing any occurrence of an optical close contact. In addition, it is possible to enhance the effect of the prevention of the crush of the vertex of the prism 116.

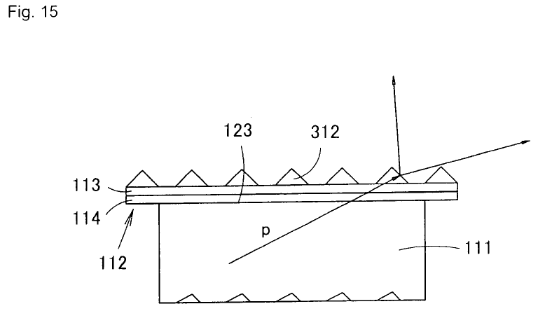

Additionally, a light beam p transmitting through the protecting sheet 112 can be deflected in an arbitrary direction by the effect of the fine patterns 312 by forming the fine pattern 312 into a conical shape such as a triangle cone or a circular cone, as shown in FIG. 15.

### Sixth Preferred Embodiment

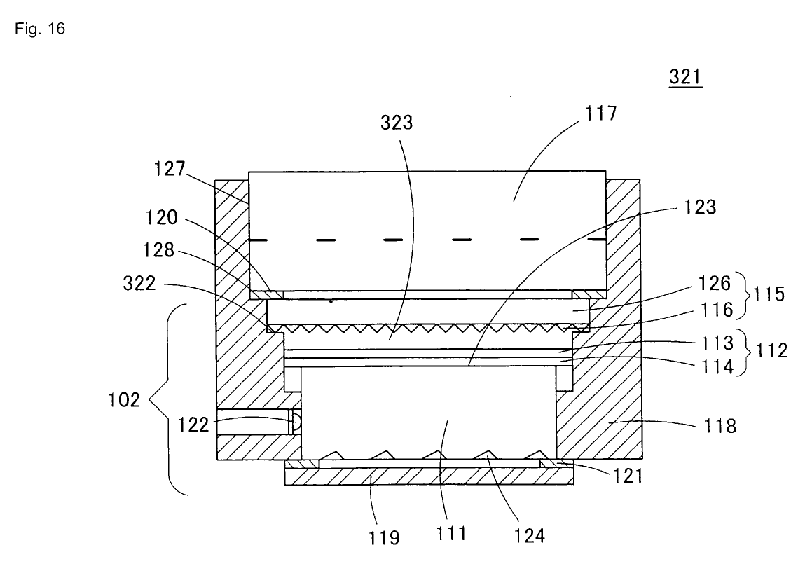

FIG. 16 is a cross-sectional view schematically showing a liquid crystal display device 321 in a sixth preferred embodiment according to the invention. A holder 118 for use in the sixth preferred embodiment has a step 322 for supporting a prism sheet 115 formed under a stepped surface 128 and at the inner surface of a through hole 127 of the holder 118. The prism sheet 115 is placed on the step 322 at its lower surface of a peripheral edge thereof, to be thus horizontally supported inside of the through hole 127 of the holder 118. A predetermined clearance 323 is defined between a prism 116 of the prism sheet 115 and an upper surface of a protecting sheet 112. The thickness of the clearance 323 should be preferably 10 μm or more. An upper limit of the thickness of the clearance 323 is at most about 100 μm in the era of a demand for thinness of the liquid crystal display device.

A vertical distance between the stepped surface 128 and the step 322 is substantially equal to the thickness of the prism sheet 115. The prism sheet 115 is pressed at the periphery thereof by a first double-sided tape 120 stuck to the stepped surface 128.

Since the prism sheet 115 is placed on the protecting sheet 112 in the liquid crystal display device 101 in the first preferred embodiment, the hardness of a transparent rubber-like resin 113 need be set to a level enough to prevent any optical close contact by the self weight of the prism sheet 115. However, the protecting sheet 112 or the prism sheet 115 is flexed due to the deformation or the like of the holder 118 depending on the configuration or usage of the liquid crystal display device, thereby raising a possibility of occurrence of the optical close contact all the time with the application of a load larger than the self weight of the prism sheet 115 on the protecting sheet 112.

Thus, the clearance 323 is defined between the prism sheet 115 and the protecting sheet 112 as measures against the above-described possibility in the sixth preferred embodiment. Specifically, even if the protecting sheet 112 is warped under severe conditions in which a heat cycle occurs (for example, from −50° C. to +100° C.) or the holder 118 is flexed due to its low rigidity to constantly warp the protecting sheet 112 or the prism sheet 115 with the application of external force in the liquid crystal display device 321 in the sixth preferred embodiment, the prism 116 of the prism sheet 115 and the protecting sheet 112 can be prevented from being brought into quasi-stationary contact with each other. Moreover, the transparent rubber-like resin 113 can prevent any breakage of the vertex of the prism 116 in the case where the vertex of the prism 116 is brought into contact with the protecting sheet 112 with the application of the external force in addition to the occurrence of the warp.

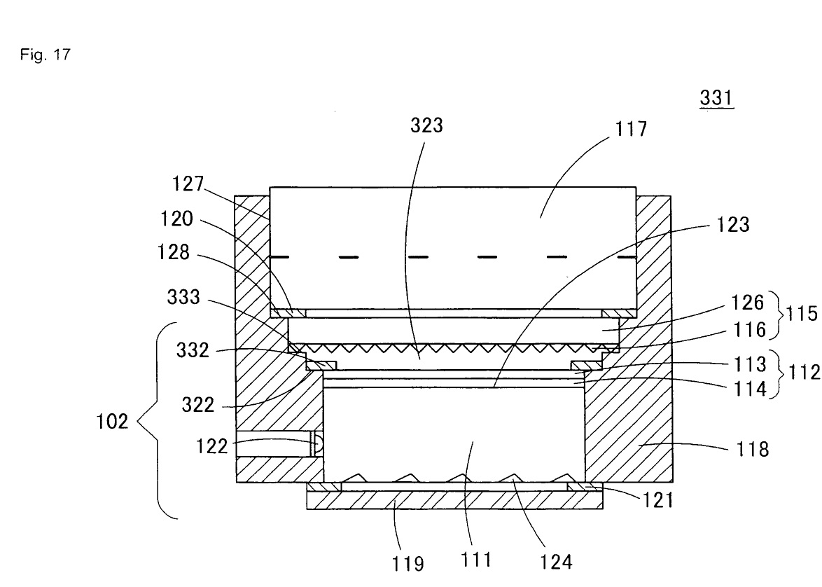

FIG. 17 is a cross-sectional view schematically showing a liquid crystal display device 331 in a modification of the sixth preferred embodiment. In this modification, a tape sticking surface 332 is provided under the step 322 and at the inner surface of the through hole 127 of the holder 118. The tape sticking surface 332 is substantially flush with the upper surface of the protecting sheet 112 housed inside of the holder 118. Thus, the periphery of the protecting sheet 112 can be secured to the holder 118 by sticking an adhesive tape 333 from the tape sticking surface 332 to the periphery of the upper surface of the protecting sheet 112, so as to prevent the protecting sheet 112 from floating.

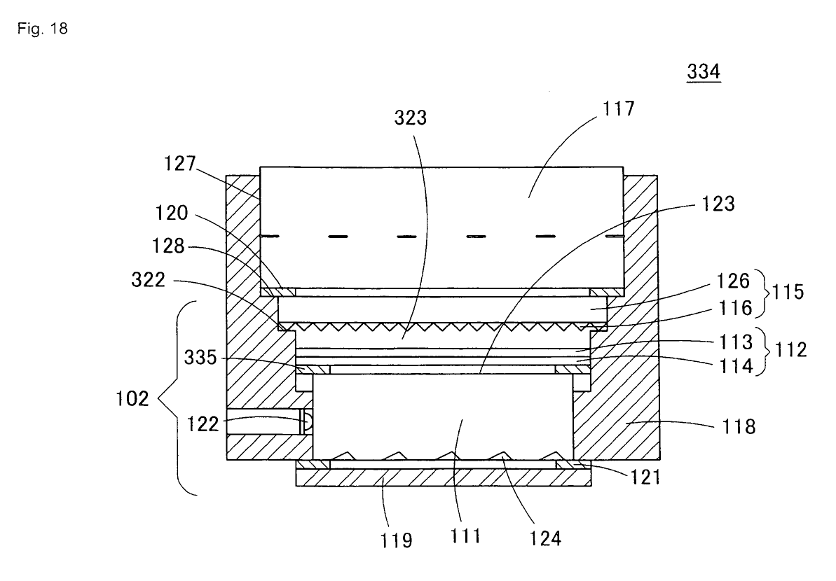

Otherwise, in order to prevent the protecting sheet 112 from floating, the periphery of the lower surface of the protecting sheet 112 may be stuck to the periphery of the upper surface of the light guiding plate 111 via a third double-sided tape 335 out of an effective region of the light guiding plate 111 in a liquid crystal display device 334 in another modification, as shown in FIG. 18.

1. A surface light source device including: a light source; a light guiding plate having uneven patterns formed for deflecting a light beam guided inward from the light source toward a light emitting plane, so as to emit the light beam from the light emitting plane in a direction substantially parallel to the light emitting plane; and a prism sheet having a plurality of prisms formed for deflecting the light beam emitted from the light emitting plane in a direction substantially perpendicular to the light emitting plane, the prisms being arranged in such a manner as to be oriented toward the light guiding plate; the surface light source device comprising:
a transparent protecting sheet having a predetermined elasticity at the surface thereof, the surface having the predetermined elasticity facing the prisms.

2. A surface light source device according to claim 1, wherein the protecting sheet includes one or a plurality of transparent rubber-like resins, each having a predetermined elasticity, formed on a transparent board.

3. A surface light source device according to claim 1, wherein the surface of the protecting sheet has the predetermined elasticity such that the surface is deformed only when external force is exerted on the prism sheet.

4. A surface light source device according to claim 1, wherein the surface of the protecting sheet is brought into contact with a vertex of the prism, and further, has the elasticity enough to support the prism without deforming the surface.

5. A surface light source device according to claim 1, wherein fine beads are dispersed in the protecting sheet.

6. A liquid crystal display device comprising:
the surface light source device according to claim 1; and
a liquid crystal display panel.

7. A liquid crystal display device comprising:
the surface light source device according to claim 2; and
a liquid crystal display panel.

8. A liquid crystal display device comprising:
the surface light source device according to claim 3; and
a liquid crystal display panel.

9. A liquid crystal display device comprising:
the surface light source device according to claim 4; and
a liquid crystal display panel.

10. A liquid crystal display device comprising:
the surface light source device according to claim 5; and
a liquid crystal display panel.
